(19) United States
(12) Patent Application Publication
(10) Pub. No.: US 2020/0355916 A1
(43) Pub. Date: Nov. 12, 2020

(54) IMAGING SYSTEM

(71) Applicant: QISDA CORPORATION, Taoyuan City (TW)

(72) Inventors: Ming-Kuen Lin, Taoyuan City (TW); Tsung-Hsun Wu, Taoyuan City (TW)

(21) Appl. No.: 16/853,726

(22) Filed: Apr. 20, 2020

(30) Foreign Application Priority Data
May 6, 2019 (CN) 201910372108.6

(51) Int. Cl. G02B 27/01; B60K 35/00

(52) U.S. Cl. CPC G02B 27/0101; G02B 27/0149; G02B 27/0179; B60K 2370/1529; G02B 2027/0123; G02B 2027/015; G02B 2027/0181; B60K 35/00

(57) ABSTRACT

An imaging system includes an image combiner, a first reflecting mirror, a second reflecting mirror, and an image generating device. An angle included between a normal of the image combiner and a level is substantially equal to 45 degrees. The first reflecting mirror is disposed with respect to the image combiner. The second reflecting mirror is disposed with respect to the first reflecting mirror. The image generating device is disposed with respect to the second reflecting mirror. A light projected by the image generating device is reflected by the second reflecting mirror and the first reflecting mirror in sequence to the image combiner, so as to form a virtual image through the image combiner.

### BACKGROUND OF THE INVENTION

### 1. Field of the Invention

The invention relates to an imaging system and, more particularly, to an imaging system capable of being installed and arranged conveniently.

### 2. Description of the Prior Art

A head up display (HUD) is used to project specific information onto a glass by optical reflection principle for a user. At present, some vehicles have been equipped with the head up display. In general, a field of view (FOV) of the head up display is related to volume. To obtain larger field of view, the volume of the head up display has to increase correspondingly. However, the head up display with large volume cannot be installed and arranged conveniently due to the limitation of space inside the vehicle.

### SUMMARY OF THE INVENTION

An objective of the invention is to provide an imaging system capable of being installed and arranged conveniently, so as to solve the aforesaid problems.

According to an embodiment of the invention, an imaging system comprises an image combiner, a first reflecting mirror, a second reflecting mirror and an image generating device. An angle included between a normal of the image combiner and a level is substantially equal to 45 degrees. The first reflecting mirror is disposed with respect to the image combiner. The second reflecting mirror is disposed with respect to the first reflecting mirror. The image generating device is disposed with respect to the second reflecting mirror. A light projected by the image generating device is reflected by the second reflecting mirror and the first reflecting mirror in sequence to the image combiner, so as to form a virtual image through the image combiner.

As mentioned in the above, the invention uses the first reflecting mirror and the second reflecting mirror to reflect the light projected by the image generating device to the image combiner, such that the image combiner forms the virtual image. The image combiner is capable of moving with respect to the level, so as to adjust the position of the virtual image according to the height of eyes of different persons. Furthermore, the image combiner is capable of rotating with respect to the level, so as to locate the image generating device and the eyes of a person at identical side or opposite sides of the image combiner. Since the angle included between the normal of the image combiner and the level is substantially equal to 45 degrees, substantial image distortion does not occur after the image combiner moves or rotates. Accordingly, a user may move or rotate the image combiner according to the requirement of installation and arrangement, such that the imaging system can be used more widely.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic view illustrating an imaging system according to an embodiment of the invention.

FIG. 2 is a schematic view illustrating that the image combiner shown in FIG. 1 moves upward with respect to the level.

FIG. 3 is a schematic view illustrating that the image combiner shown in FIG. 1 rotates 90 degrees with respect to the level.

FIG. 4 is a schematic view illustrating an imaging system according to another embodiment of the invention.

### DETAILED DESCRIPTION

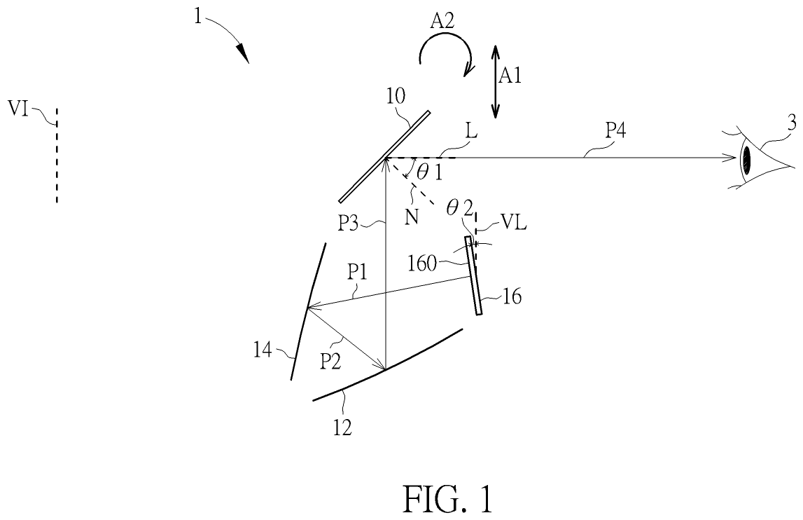

Referring to FIG. 1, FIG. 1 is a schematic view illustrating an imaging system 1 according to an embodiment of the invention. As shown in FIG. 1, the imaging system 1 comprises an image combiner 10, a first reflecting mirror 12, a second reflecting mirror 14 and an image generating device 16. In this embodiment, the imaging system 1 may be, but not limited to, a head up display or an enlarged display. The image generating device 16 may be a display, a mobile phone or other electronic devices capable of generating images. Preferably, the first reflecting mirror 12 and the second reflecting mirror 14 may be aspherical reflecting mirrors for avoiding aberration. The image combiner 10 may be a reflecting mirror or a transflective (half-refection and half-transmission) component. When the image combiner 10 is a transflective component, the transmittance and the reflectance of the image combiner 10 maybe adjusted by optical coating technology. For example, when the imaging system 1 is a head up display, the image combiner 10 may be a windshield of a vehicle and the transmittance of the image combiner 10 may be larger than the reflectance thereof, such that the imaging system 1 may be applied to an application of augmented reality (AR). Furthermore, when the imaging system 1 is an enlarged display (e.g. China Patent No. 208000411U), the reflectance of the image combiner 10 may be larger than the transmittance thereof, such that the imaging system 1 may be applied to an application of virtual reality (VR).

As shown in FIG. 1, the first reflecting mirror 12 is disposed with respect to the image combiner 10, the second reflecting mirror 14 is disposed with respect to the first reflecting mirror 12, and the image generating device 16 is disposed with respect to the second reflecting mirror 14. When the image generating device 16 is powered on, the image generating device 16 projects a light onto the second reflecting mirror 14 along a first optical path P1. Then, the first optical path P1 is reflected by the second reflecting mirror 14 to form a second optical path P2. Then, the second optical path P2 is reflected by the first reflecting mirror 12 to form a third optical path P3. Finally, the third optical path P3 forms a virtual image VI through the image combiner 10 and the third optical path P3 is reflected by the image combiner 10 to an eye 3 of a person to form a fourth optical path P4. In other words, the light projected by the image generating device 16 is reflected by the second reflecting mirror 14 and the first reflecting mirror 12 in sequence to the image combiner 10, so as to form the virtual image VI through the image combiner 10.

In this embodiment, an angle θ1 included between a normal N of the image combiner 10 and a level L is substantially equal to 45 degrees. It should be noted that the aforesaid “angle θ1 substantially equal to 45 degrees” may be that the angle θ1 is equal to 45 degrees or the angle θ1 is equal to 45 degrees plus or minus an allowable value (e.g. ±3 degrees). Accordingly, the image combiner 10 may move upward or downward along a direction indicated by a double-headed arrow A1 with respect to the level L or rotate 90 degrees toward a direction indicated by an arrow A2 without causing substantial image distortion. Furthermore, an angle θ2 included between a light projection surface 160 of the image generating device 16 and a vertical line VL may be smaller than 20 degrees and larger than 5 degrees, so as to compensate image distortion, wherein the vertical line VL is perpendicular to the level L.

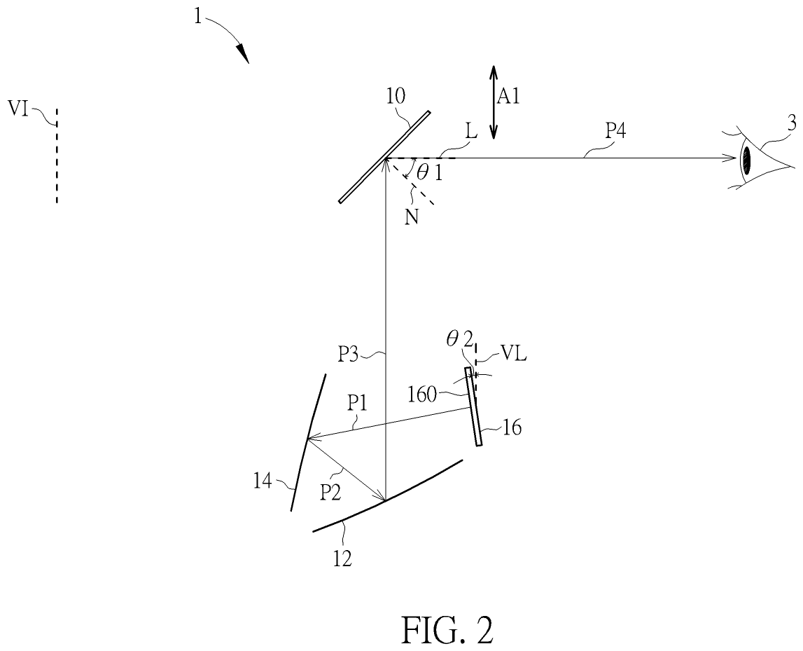

Referring to FIG. 2, FIG. 2 is a schematic view illustrating that the image combiner 10 shown in FIG. 1 moves upward with respect to the level L. As shown in FIGS. 1 and 2, the image combiner 10 may move upward or downward along the direction indicated by the double-headed arrow A1 with respect to the level L, so as to adjust the position of the virtual image VI according to the height of the eye 3 of different persons. Since the angle θ1 included between the normal N of the image combiner 10 and the level L is substantially equal to 45 degrees, substantial image distortion does not occur after the image combiner 10 moves. Furthermore, the invention may set the angle θ2 included between the light projection surface 160 of the image generating device 16 and the vertical line VL to be smaller than 20 degrees and larger than 5 degrees, so as to compensate image distortion.

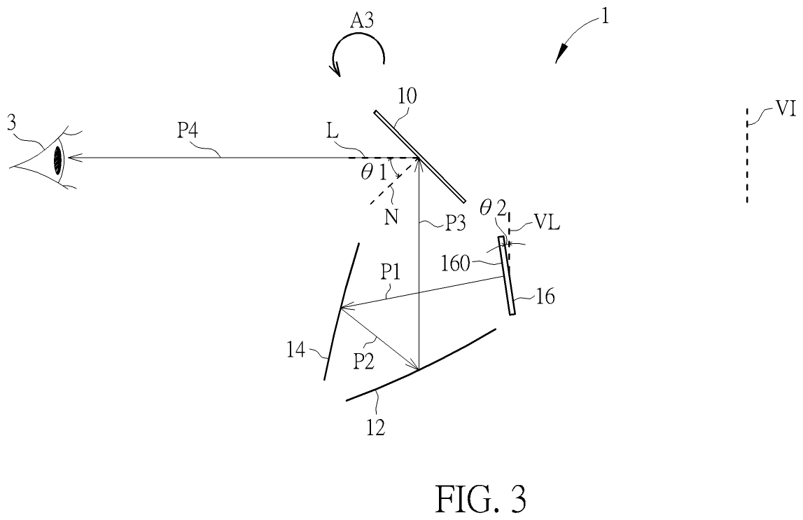

Referring to FIG. 3, FIG. 3 is a schematic view illustrating that the image combiner 10 shown in FIG. 1 rotates 90 degrees with respect to the level L. As shown in FIGS. 1 and 3, the image combiner 10 may rotate 90 degrees toward the direction indicated by the arrow A2 or A3 with respect to the level L, so as to locate the image generating device 16 and the eye 3 of a person at identical side (as shown in FIG. 1) or opposite sides (as shown in FIG. 3) of the image combiner 10. Since the angle θ1 included between the normal N of the image combiner 10 and the level Lis substantially equal to 45 degrees, substantial image distortion does not occur after the image combiner 10 rotates. Furthermore, the invention may set the angle θ2 included between the light projection surface 160 of the image generating device 16 and the vertical line VL to be smaller than 20 degrees and larger than 5 degrees, so as to compensate image distortion.

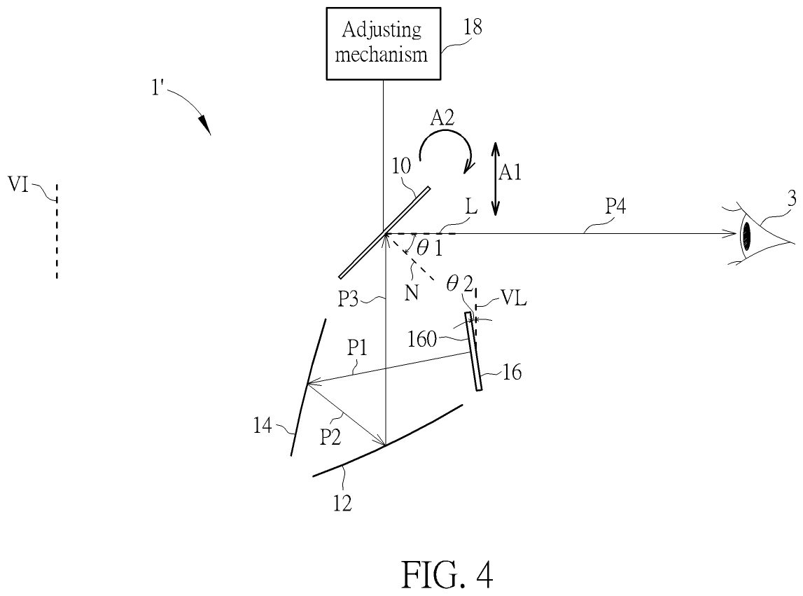

Referring to FIG. 4, FIG. 4 is a schematic view illustrating an imaging system 1′ according to another embodiment of the invention. The main difference between the imaging system 1′ and the aforesaid imaging system 1 is that the imaging system 1′ further comprises an adjusting mechanism 18, as shown in FIG. 4. In this embodiment, the adjusting mechanism 18 is connected to the image combiner 10 and the adjusting mechanism 18 is configured to selectively drive the image combiner 10 to move or rotate. Accordingly, a user may control the adjusting mechanism 18 to drive the image combiner 10 to move upward or downward along the direction indicated by the double-headed arrow A1 with respect to the level L, so as to adjust the position of the virtual image VI according to the height of the eye 3 of different persons. Furthermore, the user may also control the adjusting mechanism 18 to drive the image combiner 10 to rotate 90 degrees toward the direction indicated by the arrow A2 with respect to the level L, so as to locate the image generating device 16 and the eye 3 of a person from identical side to opposite sides (as shown in FIG. 3) of the image combiner 10. Needless to say, the user may also control the adjusting mechanism 18 to drive the image combiner 10 shown in FIG. 3 to rotate 90 degrees toward the direction indicated by the arrow A3 with respect to the level L, so as to locate the image generating device 16 and the eye 3 of a person from opposite sides to identical side of the image combiner 10. In this embodiment, the adjusting mechanism 18 may consist of motor, linkage, gear, rack and/or other linking components according to practical applications.

As mentioned in the above, the invention uses the first reflecting mirror and the second reflecting mirror to reflect the light projected by the image generating device to the image combiner, such that the image combiner forms the virtual image. The image combiner is capable of moving with respect to the level, so as to adjust the position of the virtual image according to the height of eyes of different persons. Furthermore, the image combiner is capable of rotating with respect to the level, so as to locate the image generating device and the eyes of a person at identical side or opposite sides of the image combiner. Since the angle included between the normal of the image combiner and the level is substantially equal to 45 degrees, substantial image distortion does not occur after the image combiner moves or rotates. Furthermore, the invention may set the angle included between the light projection surface of the image generating device and the vertical line to be smaller than 20 degrees and larger than 5 degrees, so as to compensate image distortion. Accordingly, a user may move or rotate the image combiner according to the requirement of installation and arrangement, such that the imaging system can be used more widely.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An imaging system comprising:
an image combiner, an angle included between a normal of the image combiner and a level being substantially equal to 45 degrees;
a first reflecting mirror disposed with respect to the image combiner;
a second reflecting mirror disposed with respect to the first reflecting mirror; and
an image generating device disposed with respect to the second reflecting mirror, a light projected by the image generating device being reflected by the second reflecting mirror and the first reflecting mirror in sequence to the image combiner, so as to form a virtual image through the image combiner.

2. The imaging system of claim 1, wherein an angle included between a light projection surface of the image generating device and a vertical line is smaller than 20 degrees and larger than 5 degrees, and the vertical line is perpendicular to the level.

3. The imaging system of claim 1, wherein the image combiner is a reflecting mirror.

4. The imaging system of claim 1, wherein the image combiner is a transflective component.

5. The imaging system of claim 1, further comprising an adjusting mechanism connected to the image combiner, the adjusting mechanism selectively driving the image combiner to move or rotate.
